(19) United States
(12) Patent Application Publication
(10) Pub. No.: US 2008/0100062 A1
(43) Pub. Date: May 1, 2008

(54) Coupling Device

(75) Inventor: Paul Gerald Aston, Staffordshire (GB)

Correspondence Address: LEYDIG VOIT & MAYER, LTD, TWO PRUDENTIAL PLAZA, SUITE 4900, 180 NORTH STETSON AVENUE, CHICAGO, IL, 60601-6731, US

(73) Assignee: Norgren Limited, Lichfield, Staffordshire (GB)

(21) Appl. No.: 11/664,331

(22) PCT Filed: Sep. 30, 2005
(86) PCT No.: PCT/GB05/03779

§ 371 Date: Dec. 10, 2007

(30) Foreign Application Priority Data
Oct. 1, 2004 (GB) 0421808.7

(51) Int. Cl. F16L 37/091; F16L 17/06; F16L 39/00

(52) U.S. Cl. 285/321; 277/608; 285/423

(57) ABSTRACT

A coupling device for a fluid pressure system comprises a housing (8) receiving a coupling body (2), and means for retaining the body (2) in the housing (8), the retaining means comprising a grab ring (36, 60, 61) having radially inner teeth (43) for engagement with the body (2) and radially outer teeth (44) for engagement with the housing (8), the grab ring (36, 60, 61) being mounted in a groove (39) in the body (2), and the grab ring (36, 60, 61) and the groove (39) being so constructed and arranged that on insertion of the body (2) into the housing (8) the outer teeth (44) are deflected by the housing (8), but on application of a removal force the grab ring (36, 60, 61) pivots in the groove (39), urging the inner teeth (43) into engagement with the body (2) and the outer teeth (44) into engagement with the housing (8).

This invention relates to a coupling device for a fluid pressure system, and in particular a pneumatic system.

Coupling devices are used in pneumatic systems for connecting the various parts together. For example, they are used to couple a tube to one or more other tubes, or to an adaptor for connection to a fluid flow port of a valve or other apparatus. A typical tube coupling device has a body with a terminal portion for receiving a tube, a seal for sealingly engaging the external surface of the tube, and tube gripping means for gripping the external surface of the tube to retain it in the body. The device will also have other terminal portions adapted for particular uses, such as another tube coupling or an adaptor, perhaps for a swivel fitting. The body will have a particular shape such as an elbow or tee, and each configuration is made separately. This means that the manufacturer or user needs to keep very many parts in stock. Clearly therefore it would be advantageous for the devices to be modular, so that a tube coupling or adaptor can simply be fitted manually into a port of a standard housing, as required by the user. This may be relatively straightforward for pressures up to about 20 bar, with tubes of diameter 4 to 16 mm (OD), as standard connection methods can be used and still allow manual insertion. It is a significant problem if pressures up to 60 bar are to be used and manual insertion is still required. This is because a connection which is strong enough to withstand the greater forces exerted at higher pressure will also then require a much greater insertion force.

According to the present invention, a coupling device for a fluid pressure system comprises a housing receiving a coupling body, and means for retaining the body in the housing, the retaining means comprising a grab ring having radially inner teeth for engagement with the body and radially outer teeth for engagement with the housing, the grab ring being mounted in a groove in the body, and the grab ring and the groove being so constructed and arranged that on insertion of the body into the housing the outer teeth are deflected by the housing, but on application of a removal force the grab ring pivots in the groove, urging the inner teeth into engagement with the body and the outer teeth into engagement with the housing.

Thus, the mounting of the grab ring to enable it to pivot means that it will engage forcibly with both the housing and the body to retain the body in the housing. The ability of the ring to deflect on insertion provides a low insertion force. The grab ring connection can therefore be used to provide modular devices.

The groove preferably has an angled rearward edge (in the direction of insertion of the body) which supports the inner surface of the grab ring in use.

Because the grab ring is mounted in a groove, the body must also have a larger diameter flange over which the ring must pass to reach the groove. The grab ring must therefore have sufficient resilience and flexibility to enable it to pass over the flange. In one embodiment the ring is split to provide the necessary flexibility. In another, the ring is continuous, but is of serpentine form to allow it to stretch over the flange. In either case, the ring has a substantially conical profile.

The radially outer teeth are preferably provided by discontinuous sharp edges on the outer peripheral edge of the ring.

The radially inner teeth are also preferably provided by discontinuous sharp edges, on the inner peripheral edge of the ring. However if the ring is a split ring, the whole of the inner peripheral edge of the ring may have a sharp edge, and act as the inner teeth.

The ring is preferably of stainless steel. 316 half-hard stainless steel is preferred.

The housing and body are conveniently of plastics material. The body also provides a mounting for a seal, such as an O-ring to seal the body in the housing. The seal is preferably mounted forward of the grab ring, in the insertion direction, as this assists insertion, ensuring that the insertion force is kept low.

Some embodiment of the invention are illustrated by way of example in the accompanying drawings, in which:

FIG. 1 is a section through a housing and a tube coupling body;

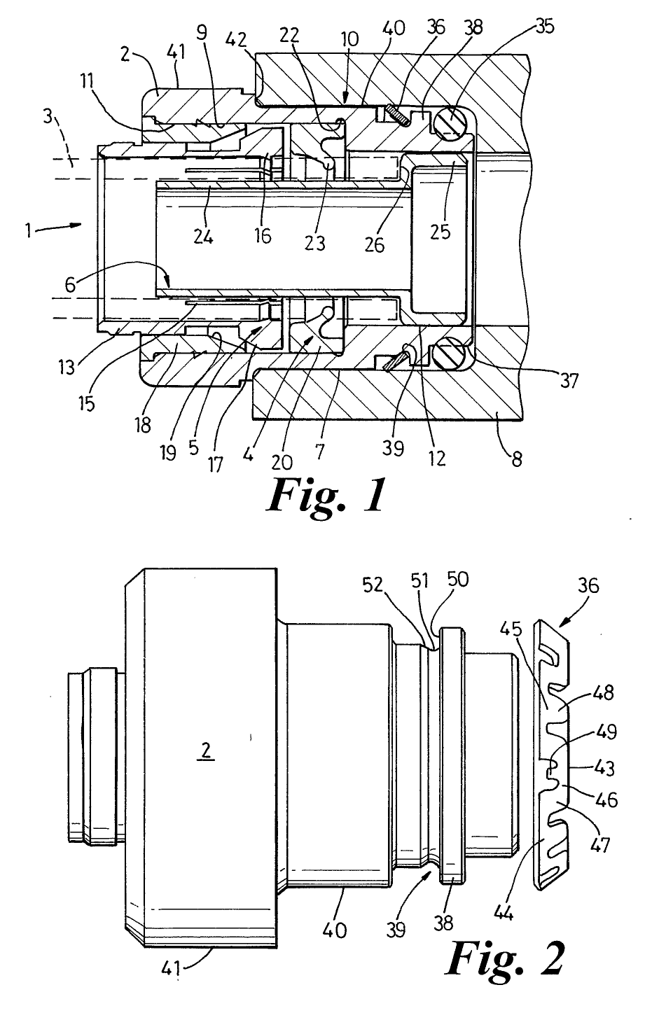

FIG. 2 shows a side view of the body of FIG. 1 with a grab ring before assembly;

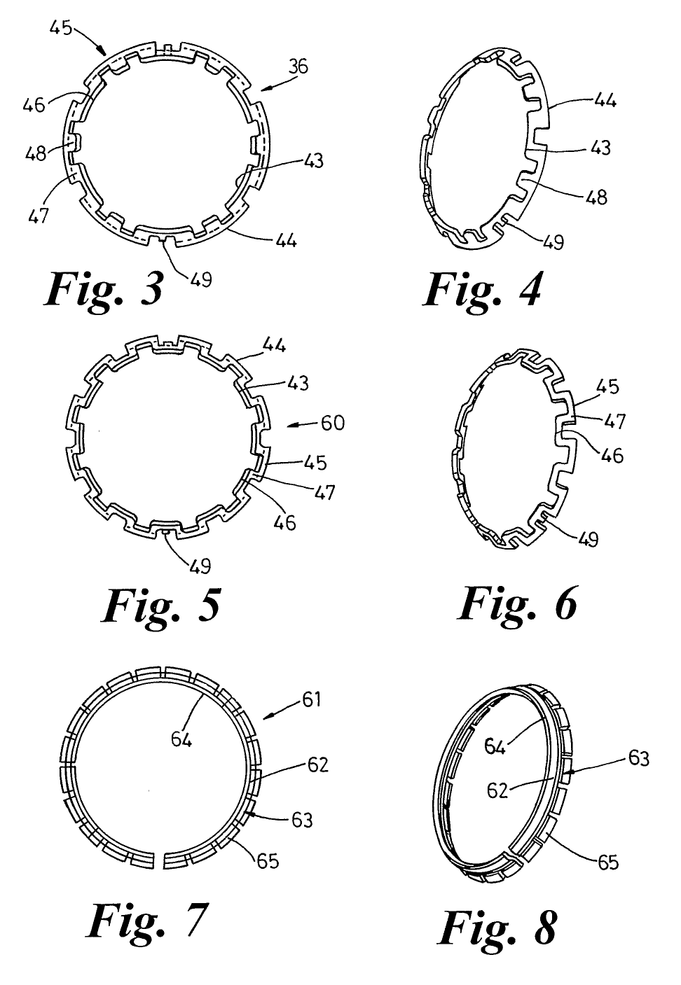

FIGS. 3 and 4 are a plan and perspective view respectively of the grab ring of FIGS. 1 and 2;

FIGS. 5 and 6 are similar to FIGS. 3 and 4 but show a modified grab ring; and

FIGS. 7 and 8 show a further embodiment of the grab ring.

The tube coupling device 1 shown in the drawings is of the releasable push-in type, and is intended for use in pneumatic systems, to connect a tube to one or more other tubes, or adaptors.

The device 1 comprises a body 2 adapted to receive a tube 3 (shown in dotted lines), sealing means 4 for sealingly engaging the external surface of the tube 3, and tube gripping means 5 for gripping the external surface of the tube 3 to retain it in the body 2. The device 1 also has a stepped tube support member 6. The body 2 is itself sealingly and fixedly mounted by a seal 35 and a grab ring 36 in a port 7 of a connector housing 8, enabling the tube 3 to be connected to other tubes or adaptors of the pneumatic system.

The housing 8 is of plastics material, and the port 7 has a plain bore. The body 2 is of plastics material and of annular construction; with a stepped internal bore 9 and a stepped external surface 10. The internal bore 9 has a larger diameter portion 11 at its outer end, in which the gripping means 5 and sealing means 4 are received, and a portion 12 of smaller diameter at its inner end in which the inner end of the support member 6 is received, and which is also adapted to receive the end of the tube 3 in use. The external surface 10 has a portion 37 of smallest diameter at its inner end, on which the seal 35 in the form of an O-ring is mounted. Working towards the outer end, there is first a flange 38 of larger diameter, and then a profiled groove 39 (best seen in FIG. 2) for receiving the grab ring 36. A plain cylindrical portion 40 is followed by a larger diameter portion 41, with a shoulder 42 defined at the step being adapted to abut the housing 8. The grab ring 36 and groove 39 will be described in more detail below.

The gripping means 5 comprises a collet member 13, in the form of a cylindrical metal tube with an enlarged inner end 14. At its inner end the tube has slits 15, and has triangular projections 16 extending radially inwardly to form gripping teeth. A conical surface 17 is provided externally on the enlarged end 14. The collet member 13 is retained in the body 2 by an annular plug 18 fixed in the outer end of the bore 9. The collet member 13 is adapted to slide axially in the plug 18, which has a conical internal surface 19 which engages the conical surface 17 of the collet member 13 to urge the gripping teeth radially inwardly to grip the tube 3 in use. In the position shown in FIG. 2 the teeth do not exert a great deal of force, and the collet member 13 can be moved inwardly to allow the tube 3 to be removed.

The sealing means 4 comprises a lip seal 20 mounted at the shoulder 21 between the diameter portions 11, 12 of the bore 9. The seal 20 has an external sealing surface 22 to seal against the bore 9, and an internal lip 23 to seal against the tube 3 in use. In the position shown in FIG. 2, there is an axial clearance between the collet member 13 and the seal 20. The seal 20 may be an O-ring instead.

The tube support member 6 is of plastics material, and is of stepped cylindrical outline. A longer outer end portion 24 is of smaller diameter to fit into the tube 3, while a shorter inner end portion 25 is of larger diameter to slide in the bore portion 12. A shoulder 26 between the portions 24, 25 forms a stop for the end of the tube 3.

The grab ring 36 is illustrated in FIGS. 2 to 4 on an enlarged scale. It has radially inner teeth 43 for engagement with the body 2, and radially outer teeth 44 for engagement with the housing 8. The grab ring 36 has a conical profile, with an unbroken serpentine form, of six spaced outer peripheral sections 45 alternating with six spaced inner peripheral sections 46, each adjacent inner and outer section being joined by a radial leg 47. Each outer section 45 also has a projection 48 extending radially inwardly to the inner periphery to provide strength, while each of one pair of diametrally opposed inner sections 46 has a projection 49 extending radially outwardly, but stopping short of the outer periphery.

The inner teeth 43 are formed as sharp surfaces on the inner sections 46, while the outer teeth 44 are formed as sharp surfaces on the outer sections 45. Both the inner and outer teeth are discontinuous. The grab ring 36 is made of stainless steel, and the design provides sufficient flexibility to stretch over the flange 38 to enable it to be mounted in the groove 39.

The groove 39, as best seen in FIG. 2, has a radial edge 50 with the flange 38, leading to a curved portion 51 in which the grab ring 36 is housed, and terminating at its rearward end in an angled portion 52. The angled portion 52 serves to support the inner peripheral edged of the grab ring 36 in use.

For use, the body 2 is assembled with the tube support member 6, the seal 20, the collet member 13, and the plug 18. The grab ring 36 and O-ring 35 are then assembled on the outside of the body 2. The whole assembly is then inserted into the port 7, until the shoulder 42 abuts the end of the housing 8. During insertion, the O-ring 35 will deform, and the outer periphery of the grab ring 36 will be deflected resiliently by the bore of the port 7. When the body 2 is inserted fully, the O-ring 35 will seal between the body 2 and the housing 8 the grab ring 36 will try to resume its previous shape, causing the outer teeth 43 to dig into the bore in the housing 8, and the inner teeth 44 to dig into the curved groove portion 51, to retain the body 2 in the housing 8. The inner peripheral edge of the grab ring 36 is then supported by the angled portion 52 of the groove 39.

The tube 3 can then be inserted, through the collet member 13 and the seal 20, and fitting over the tube support member 6.

When the system is pressurised, the pneumatic fluid exerts a force on the body 2, trying to move it out of the housing 8. This is resisted by the grab ring 36, which pivots about the inner teeth 44 in a direction to increase its radial dimension, causing the outer and inner teeth to dig further into the housing 8 and body 2. The curved portion 51 assists in supporting the grab ring 36 in the pivoting movement.

The grab ring 36 can therefore withstand high pressures, of up to 60 bar, and still retain the body 2 in the housing 8. At the same time, the grab ring 36 has the resilience and flexibility to enable it to pass over the flange 38.

In a modification (not shown) the flange 38 may be replaced by a plastics support ring, which is split to enable it to be mounted in a further groove in the body 2 between the groove 39 and the O-ring 35. The further groove is deeper than the groove 39 to provide location for the support ring. The support ring will back up the grab ring 36, and also allows easier assembly of the grab ring, as it no longer has to pass over the flange 38.

It will be appreciated that the grab ring 36 and O-ring 35 could be used to mount a body of a different coupling device for a pneumatic system, thus enabling a modular system to be devised.

The grab ring 60 shown in FIGS. 5 and 6 is a modified version of that shown in FIGS. 2 to 4, and corresponding reference numerals have been applied to corresponding parts. Like the grab ring 36, the grab ring 60 has a conical profile, and alternating outer and inner peripheral sections 45, 46 joined by radial legs 47.

However, in the grab ring 60 the sections 45, 46 are shorter than in the previous embodiment, so that there are twelve of each. Each section has a sharp surface forming a tooth, so that there are more, but shorter, teeth on the grab ring 60. The pair of projections 49 is also provided. The grab ring 60 works in the same way as the grab ring 36, with the arrangement providing sufficient resilience and flexibility to pass over the flange 38, while having the strength to retain the body 2 in the housing 8 under high pressures.

FIGS. 7 and 8 show a further modified grab ring 61. This ring is split, to provide the flexibility to pass over the flange 38, and so does not have the serpentine form of the two previous embodiments. The grab ring 61 is still of substantially conical profile, having a slightly curved inner ring 62 and a flared outer ring 63 to provide strength. The inner ring has a continuous inner periphery 64 (broken only by the split) with a sharp surface to provide the toothed engagement with the body 2. The outer ring 63 is slotted to provide twenty sections 65, each of which has a sharp surface to provide the outer teeth engaging with the housing 8. The assembly and operation of the grab ring 61 is otherwise the same as that of the previous embodiments.

1. A coupling device for a fluid pressure system comprises a housing receiving a coupling body, and a retaining mechanism for retaining the body in said housing, said retaining mechanism comprising a grab ring, said grab ring having radially inner teeth for engagement with said body and radially outer teeth for engagement with said housing, said grab ring being mounted in a groove in the body, and said grab ring and said groove being so constructed and arranged that on insertion of said body into said housing said outer teeth are deflected by said housing, but on application of a removal force said grab ring pivots in said groove, urging said inner teeth into engagement with said body and said outer teeth into engagement with said housing.

2. A coupling device according to claim 1, in which said groove has an angled rearward edge, angled in the direction of insertion of said body, which supports the inner surface of said grab ring in use.

3. A coupling device according to claim 1, in which said body has a larger diameter flange over which said grab ring must pass to reach the groove.

4. A coupling device according to claim 1, in which said ring has a substantially conical profile.

5. A coupling device according to claim 1, in which said radially outer teeth are provided by discontinuous sharp edges on the outer peripheral edge of said ring.

6. A coupling device according to claim 1, in which said radially inner teeth are provided by discontinuous sharp edges, on the inner peripheral edge of said ring.

7. A coupling device according to claim 1, in which said ring is split.

8. A coupling device according to claim 7, in which the whole of the inner peripheral edge of said ring has a sharp edge, and acts as the inner teeth.

9. A coupling device according to claim 1, in which said ring is continuous and of serpentine form.

10. A coupling device according to claim 1, in which said ring is made of stainless steel.

11. A coupling device according to claim 10, in which the stainless steel is 316 half-hard stainless steel.

12. A coupling device according to claim 1, in which the housing and body are made of a plastics material.

13. A coupling device according to claim 1, in which said body provides a mounting for a seal to seal said body in said housing.

14. A coupling device according to claim 13, in which the seal is an O-ring seal.

15. A coupling device according to claim 13, in which said seal is mounted forward of the grab ring, in an insertion direction.
